(19) United States
(12) Patent Application Publication
(10) Pub. No.: US 2026/0264936 A1
(43) Pub. Date: Sep. 10, 2026

(54) FRAMEWORK WITH DIVIDERS FOR STORING AND TRANSPORTING PIECE GOODS

(71) Applicant: CONTEYOR INTERNATIONAL NV, Merelbeke (BE)

(72) Inventor: Petra VAN NECK, Merelbeke (BE)

(21) Appl. No.: 19/491,274

(22) PCT Filed: Jun. 7, 2024
(86) PCT No.: PCT/EP2024/065701

§ 371 Date: Dec. 8, 2025

(30) Foreign Application Priority Data
Jun. 9, 2023 (BE) 2023/5477

(51) Int. Cl. B65D 25/04; B65G 1/02; D03D 9/00; D03D 15/283; D06M 15/227; D06M 101/20; D06N 3/00; D06N 3/04

(52) U.S. Cl. CPC B65D 25/04; B65G 1/02; D03D 9/00; D03D 15/283; D06M 15/227; D06N 3/0006; D06N 3/0038; D06N 3/045; D06M 2101/20; D10B 2321/021; D10B 2401/063; D10B 2505/10

(57) ABSTRACT

The invention relates to a framework (1) provided with dividers (2) for the temporary storage and transport of piece goods (3), wherein the dividers are composed of a textile, said textile having a weight of maximally 400 g/m² and comprising: a) a woven polypropylene (PP) or polyethylene (PE) scrim, said scrim having a first and a second surface, and b) a PP or PE coating layer disposed on said first and/or second surface of the woven scrim; wherein said scrim has a weight of maximally 200 g/m² and wherein one coating layer has a weight of maximally 100 g/m².

### FIELD OF THE INVENTION

The present invention concerns a framework provided with dividers for the temporary storage and transport of piece goods, wherein the dividers are composed of a textile, said textile comprising a) a woven polypropylene (PP) or polyethylene (PE) scrim, said scrim having a first and a second surface, and b) a PP or PE coating layer disposed on said first and/or second surface of the woven scrim.

### BACKGROUND

Piece goods are often stored and transported in pouches, which are provided in a framework via a pouch system. Such devices, such as for example U-shaped pouches or flexible compartment systems, have their typical field of application in the automotive industry for transportation of the most diverse parts of motor vehicles, in particular also body parts such as doors, door linings and suchlike. The purpose is that the piece goods can be quickly and easily packaged and removed from the device. These pouches can often be folded to save space in an unloaded state and thus save transportation costs. They are provided as a textile material which should be flexible.

EP2684810, for instance, describes such framework provided with a pouch system for the temporary storage and transport of piece goods in flexible pouches of the pouch system. Said pouches are confectioned from a multi-layered strip material comprising a knitted fabric. Said pouches, however, have a rather low breaking strength, and are thus not suitable for carrying heavy loads or for transport by which higher forces are acting on the textile or fabric. Additionally, EP4214133 and WO2008090070 outline flexible transport systems incorporating subdivision elements, potentially for use in transport containers or frames. Nevertheless, the combination of robust yet flexible materials remains an important concern.

A known strong and flexible material, as is required for dividers in transport containers, is a polyester (PES) scrim coated with polyvinylchloride (PVC). A first disadvantage of PVC is, however, that it is a rather heavy material, which is not desirable as it results in a higher cost of transport. A second and important disadvantage is that PVC nor PES are recyclable. Such strong flexible PVC-coated PES scrim is thus not a sustainable option.

There is thus a need for an improved framework with dividers composed of a textile which is flexible, light, strong, cheap enough and more durable than the known and generally used materials in systems for storing and transporting piece goods. The present invention aims to resolve at least some of the problems and disadvantages mentioned above.

### SUMMARY OF THE INVENTION

The present invention and embodiments thereof serve to provide a solution to one or more of above-mentioned disadvantages. To this end, the present invention relates to a framework according to claim 1. In particular, the framework is provided with dividers for the temporary storage and transport of piece goods, wherein the dividers are composed of a textile, said textile having a weight of maximally 400 g/m² and comprising: a) a woven polypropylene (PP) or polyethylene (PE) scrim, said scrim having a first and a second surface, and b) a PP or PE coating layer disposed on said first and/or second surface of the woven scrim; wherein said scrim has a weight of maximally 200 g/m² and wherein one coating layer has a weight of maximally 100 g/m².

Preferred embodiments of the framework are shown in any of the claims 2 to 14.

Such framework with dividers composed of said textile has the advantage that it has a particularly low weight, lower than a corresponding framework with dividers composed of a PVC-coated PES scrim would have, while providing sufficient strength and flexibility to be used for storing and transporting piece goods, thereby avoiding tearing and breaking during transport.

### DESCRIPTION OF FIGURES

The following numbering refers to: (1) framework; (2) divider; (3) piece goods; (4) yarns; and (5) seam. The following description of the figures of specific embodiments of the invention is merely exemplary in nature and is not intended to limit the present teachings, their application or uses. Throughout the drawings, corresponding reference numerals indicate like or corresponding parts and features.

FIG. 1 schematically presents a framework (1) comprising dividers (2) for the storage and transport of piece goods (3), wherein the dividers are composed of a specific textile, of an embodiment of the present invention.

FIG. 2 presents in more detail the textile of which the dividers are composed, and shown the multifilament yarns (4) of the scrim with a coating layer disposed on its surfaces, according to an embodiment of the present invention.

FIG. 3 presents a further view on the dividers composed from pieces of said textile sewn together by way of seams (5), according to an embodiment of the present invention.

FIG. 4 shows a side view (FIG. 4A) and front view (FIG. 4B) of a measuring set up to measure permanent elongation of a textile upon or after the application of a load to said textile, as described in Example 3.

FIG. 5 schematically shows a textile to be placed on a frame in a measuring set up to measure permanent elongation of a textile, as described in Example 3.

FIG. 6 presents measuring results of elongation of a textile before (FIG. 6A), upon (FIG. 6B), or after (FIG. 6C) the application of a load to said textile, as described in Example 3.

### DETAILED DESCRIPTION OF THE INVENTION

The present invention concerns a framework provided with dividers for the temporary storage and transport of piece goods, wherein the dividers are composed of a textile having a weight of maximally 400 g/m² and comprising: a) a woven polypropylene (PP) or polyethylene (PE) scrim, said scrim having a first and a second surface, and b) a PP or PE coating layer disposed on said first and/or second surface of the woven scrim.

Said dividers composed of said textile have a particularly low weight, lower than a corresponding PES scrim coated with PVC would have, but provide sufficient strength and flexibility to be used for storing and transporting piece goods, thereby avoiding tearing and breaking during transport, similarly as such corresponding PES-PVC material would provide.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

“Fabric” or “textile” as used herein refers to a sheet structure made from fibers, filaments or yarns.

“Fiber” as used herein refers to the basic threadlike greatly elongated natural or synthetic filament typically capable of being spun into yarn, from which yarns and textiles are made. It differs from a particle by having a length at least 100 times its width. Natural fibers are either of animal (wool, silk), vegetable (cotton, flax, jute) or mineral (asbestos) origin. Man-made fibers may be either polymers synthesized from chemical compounds (polyester, polypropylene, nylon, acrylic etc.) modified natural polymers (rayon, acetate) or mineral (glass).

“Filament” as used herein refers to a fiber of indefinite length.

“A yarn” as used herein refers to a continuous strand of fibers or filaments that are twisted together, to enable its conversion into a woven, knitted or braided fabric or textile.

A “woven” textile as used herein refers to an textile produced using a method of weaving, in which two distinct sets of yarns or threads are interlaced at right angles to form a fabric or cloth.

“Scrim” as used herein refers to a woven, generally very open fabric or textile, such as a netting, used as a support or a backing, generally used in clothing, curtains, building, and industry.

In a first aspect, the invention provides a framework provided with dividers for the temporary storage and transport of piece goods, wherein the dividers are composed of a textile, said textile having a weight of maximally 400 g/m² and comprising: a) a woven polypropylene (PP) or polyethylene (PE) scrim, said scrim having a first and a second surface, and b) a PP or PE coating layer disposed on said first and second surface of the woven scrim; wherein said scrim has a weight of maximally 200 g/m² and both coating layers combined have a weight of maximally 200 g/m² as measured by ISO 12127 (Textile fabrics—Determination of mass per unit area using small samples).

By providing a textile having a total weight of maximally 400 g/m², which is lower than a known PVC-coated PES scrim, comprising a scrim and a coating layer disposed on said scrim, a textile having sufficient strength and flexibility while having a low weight can be obtained, therefore being suitable as dividers in a framework to be used in storing and transporting of piece goods, preferably in returnable packaging. Said textile is sufficiently strong to withhold the weight of heavy items and is sufficiently flexible and soft to be used as a material for storing and transporting items prone to scratches. In addition, by providing a textile comprising PP or PE materials, such as (linear) low-density PE ((L)LDPE), the textile is recyclable and thus sustainable. Preferably, when the woven scrim is a PP scrim, the coating layer is a PP coating layer, or when the woven scrim is a PE scrim, the coating layer is a PE coating layer, thereby resulting in a 100% PP or PE textile. This adds to the recyclability and the sustainability of the textile and thus the framework as described herein.

In an embodiment, the textile even has a lower total weight of maximally 395 g/m², 390 g/m², 385 g/m², 380 g/m², 375 g/m², 370 g/m², 365 g/m², 360 g/m², 355 g/m², 350 g/m² or even only 345 g/m². In an embodiment, the total weight of the textile is between 300 g/m² and 400 g/m², such as between 310 g/m² and 390 g/m², between 320 g/m² and 380 g/m², between 330 g/m² and 370 g/m², between 340 g/m² and 360 g/m², between 340 g/m² and 350 g/m², such as about 345 g/m².

In another or further embodiment, said scrim has a weight of maximally 200 g/m², preferably 198 g/m², 196 g/m², 194 g/m², 192 g/m², 190 g/m², 188 g/m², 186 g/m², 184 g/m², 182 g/m², or even only 180 g/m². In another or further embodiment, said scrim has a weight of between 170 g/m² and 200 g/m², preferably between 170 g/m² and 195 g/m², between 170 g/m² and 190 g/m², between 170 g/m² and 185 g/m², between 175 g/m² and 200 g/m², between 175 g/m² and 195 g/m², between 175 g/m² and 190 g/m², between 175 g/m² and 185 g/m², or preferably about 180 g/m².

In another or further embodiment, the scrim has a thickness of between 0.30 and 0.50 mm, preferably between 0.35 and 0.50 mm, or between 0.30 and 0.45 mm, more preferably between 0.35 and 0.45, such as 0.40 mm, preferably as measured by EN 20534.

In another or further embodiment, both coating layers combined have a weight of maximally 200 g/m², preferably 198 g/m², 196 g/m², 194 g/m², 192 g/m², 190 g/m², 188 g/m², 186 g/m², 184 g/m², 182 g/m², 180 g/m², 178 g/m², 176 g/m², 174 g/m², 172 g/m², 170 g/m², 168 g/m², 166 g/m², or even only 165 g/m². In another or further embodiment, said coating layers have a combined weight of between 150 g/m² and 200 g/m², preferably between 150 g/m² and 195 g/m², between 150 g/m² and 190 g/m², between 150 g/m² and 185 g/m², between 150 g/m² and 180 g/m², between 150 g/m² and 175 g/m², between 150 g/m² and 170 g/m², between 155 g/m² and 195 g/m², between 155 g/m² and 155 g/m², between 155 g/m² and 185 g/m², between 155 g/m² and 180 g/m², between 155 g/m² and 175 g/m², between 155 g/m² and 170 g/m², between 160 g/m² and 195 g/m², between 160 g/m² and 190 g/m², between 160 g/m² and 185 g/m², between 160 g/m² and 180 g/m², between 160 g/m² and 175 g/m², between 160 g/m² and 170 g/m², preferably about 165 g/m². It is thus clear that when only one of both surfaces of the scrim are coated, the above mentioned weights should be divided by 2, i.e. when both coating layers combined have a weight of maximally 200 g/m², only one coating layer has a weight of maximally 200/2=100 g/m².

A textile comprising a PP or PE scrim with any of the above weights in combination with the PP or PE coating layers of any of the above weights results in a sufficiently flexible and strong textile to be used in transporting and storing piece goods.

The weights as described herein are measured using the standard measuring method according to ISO 12127.

Preferably, the coating improves the flexibility and elasticity of the PP or PE scrim.

In another or further embodiment, the coating comprises one or more resins and one or more additives. Said coating provides the scrim layer with the desired flexibility and elasticity.

Non-limiting examples of such resins are: polyethylene (PE), low-density polyethylene (LDPE), linear low-density polyethylene (LLDPE), high-density polyethylene (HDPE), ethylene-vinyl acetate (EVA), polypropylene (PP), low-density polypropylene (LDPP), and high-density polypropylene (HDPP).

LDPE is a flexible and durable polymer that can be used in coatings for textiles. It provides good adhesion and can be used in both solvent-based and water-based formulations.

LLDPE is a type of thermoplastic polymer that is similar to LDPE, but has a higher degree of crystallinity. LLDPE has good flexibility and impact resistance, as well as resistance to environmental factors such as moisture and chemicals. It is often used in coatings for textiles because of its good adhesion and flexibility.

HDPE is known for its high strength and durability, as well as its resistance to impact, moisture, and chemicals. In textile coatings, HDPE can provide good adhesion and flexibility, as well as resistance to environmental factors.

EVA is a copolymer of ethylene and vinyl acetate that is commonly used as a binder in textile coatings. It provides good adhesion and flexibility.

LDPP is a type of thermoplastic polymer that is similar to LDPE, but with a higher melting point. LDPP has good flexibility and impact resistance, as well as resistance to environmental factors such as moisture and chemicals. It can be used in coatings for textiles to provide good adhesion and flexibility.

HDPP is a type of thermoplastic polymer that is similar to HDPE, but with a higher melting point. HDPP is known for its high strength and durability, as well as its resistance to impact and moisture. It can be used in coatings for textiles to provide good adhesion and flexibility, as well as resistance to environmental factors such as heat and chemicals.

Non-limiting examples of such additives are: wax, antioxidants, and crosslinkers.

Wax can be added to a polyethylene-based coating to improve water repellency and abrasion resistance. Antioxidants can be added to improve resistance to UV light and heat. Crosslinkers can be added to improve the durability and chemical resistance of the coating.

Textiles and scrims comprise a machine direction (MD) and a cross direction (CD). “Cross direction” as used herein refers to the width direction, within the plane of the textile or scrim, that is perpendicular to the direction in which the textile or scrim is being produced by the machine. “Machine direction” as used herein refers to the long direction within the plane of the textile or scrim, that is the direction in which the textile or scrim is being produced by the machine.

In an embodiment, said scrim comprises two sets of PP or PE multifilament yarns. Preferably, said scrim comprises a set of PP or PE multifilament yarns in the MD and a set of PP or PE multifilament yarns in the CD. Further, preferably, said scrim has 15 to 19 yarns per inch of scrim in both the MD and CD, preferably 16 to 18 yarns per inch of scrim in both the MD and CD, most preferably 17 yarns per inch of scrim in both the MD and CD. Such scrim can be referred to as a 17×17/inch scrim, which refers to the “weave density” of the scrim. This measurement is commonly used to indicate the fineness or coarseness of the scrim, and influences its weight and thickness. The weave density of a textile scrim can affect its strength and durability. 15×15/inch to 19×19/inch are particularly useful in providing sufficient strength to the textile of the framework, while allowing sufficient flexibility and elasticity to the dividers to be particularly suitable for use in transporting and storing piece goods.

The term “breaking strength” as measured by the ASTM D 5035-test, in the present invention refers to the maximum force required to break a material under tension. It is often used as a measure of the strength of a material and is an important parameter in the textile industry. The ASTM D 5035 standard is a standard test method for measuring the breaking strength and elongation of textile fabrics. This standard describes a procedure for testing the strength of a sample of fabric by subjecting it to a controlled tensile force until it breaks. In this test, a rectangular sample of fabric is prepared with a specified width and length. The sample is clamped at the ends and subjected to a gradually increasing force until it breaks. The maximum force required to break the sample is recorded as the breaking strength, and the amount of deformation that occurs during the test is also recorded as the “elongation” (see further).

The term “MD breaking strength” in the present invention refers to the breaking strength, wherein said sample corresponds in longitudinal direction to the machine direction of the fabric (cf. MD: “machine direction”). The term “CD breaking strength” in the present invention refers to the breaking strength, wherein said sample corresponds in longitudinal direction to the direction cross to the machine direction of the fabric (cf. CD: “cross direction”).

In an embodiment, the breaking strength of the textile in both directions (MD and CD) is at least 1500 N, preferably at least 1550 N, 1600 N, 1650 N, 1700 N, 1750 N, 1800 N, 1850 N, 1900 N, or even at least 1950 N as measured by ASTM D 5035. PES-PVC has a breaking strength of between 1980 N and 2140 N. The textile of the present invention thus preferably has a breaking strength of at least 1950 N in both directions, thereby being a suitable replacement for such PES-PVC, while still being recyclable.

“Elongation at break”, see elongation described above in relation to the ASTM D 5035-test, also known as fracture strain, is a measure of the amount of deformation or stretching that occurs in a material before it breaks, and is one of the parameters measured in the ASTM D 5035 test along with the breaking strength. Is typically expressed as a percentage and is calculated by dividing the change in length of a material at the point of breakage by its original length. It expresses the capability of fibers to resist changes of shape without crack formation. In an embodiment, the elongation at break in both directions is between 15% and 28%, more preferably between 17% and 26%, or between 19% and 25.5%, as measured by ASTM D 5035.

In an embodiment, the breaking strength of the textile in both directions (MD and CD) is at least 1500 N, and the elongation at break in both directions is between 15 and 28% as measured by ASTM D 5035.

The “tearing strength” of a fabric or textile refers to its resistance to tearing force. Usually textile tears when it is snagged by a sharp object and the immediate small puncture is converted into a long rip. It is thus a measure of its resistance to the propagation of a tear or rip. ASTM D 5587 is a standard test method for determining the tearing strength of textiles by the trapezoid procedure. In the ASTM D 5587 test, a trapezoidal-shaped specimen of the fabric is cut and a small slit is made at the narrow end. The specimen is then clamped into the jaws of a tensile testing machine, with the slit in the specimen aligned with the center of the jaws. The jaws are then pulled apart at a constant rate until the specimen tears completely, with the maximum force required to tear the specimen recorded as the tearing strength. Tearing is probably the most common type of strength failure, so testing textile tearing strength is very important.

In an embodiment, the tearing strength of the textile is in both directions (MD and CD) at least 125 N as measured by ASTM D 5587, preferably at least 126 N, at least 127 N, at least 128 N, at least 128 N, at least 129 N, at least 130 N, at least 131 N, at least 132 N, at least 133 N, at least 134 N, at least 126 N, at least 127 N, at least 128 N, at least 128 N, at least 129 N, at least 130 N as measured by ASTM D 5587. In an embodiment, the tearing strength of the textile is between 125 N and 155 N, preferably between 127 N and 153 N, between 129 N and 151 N, or between 129 N and 149 N as measured by ASTM D 5587. In an embodiment, the tearing strength of the textile in the machine direction is between 125 N and 140 N, preferably between 125 N and 135 N, most preferably about 130 N as measured by [measuring standard]. In an embodiment, the tearing strength of the textile in the cross direction is between 135 N and 155 N, preferably between 140 N and 150 N, between 145 N and 150 N, most preferably about 148 N as measured by ASTM D 5587.

A textile with such a tearing strength is particularly suitable for containing, storing, and transporting heavier materials and goods with sharp edges, while avoiding said sharp edges tearing the textile.

“Bursting strength” of a textile is a measure of the ability of a material to resist rupture or burst when pressure is applied. The pressure should be applied to a specified circular area of the test piece of material. Bursting strength ASTM D3787 is a standard that describes a method for testing the bursting strength of fabrics. In the ASTM D3787 test, a circular specimen of the fabric is clamped between two annular plates and pressure is applied to the specimen by a rubber diaphragm until it bursts.

The maximum pressure at which the specimen bursts is recorded as the bursting strength.

In an embodiment, the textile of the present framework has a bursting strength of at least 3000 N with a displacement of at least 25 mm as measured by ASTM D3787. In an embodiment, the bursting strength is at least 3050 N, 3100 N, 3150 N, 3200 N, 3250 N, 3300 N, 3350 N, 3400 N, 3450 N, or even 3500 N, with a displacement of between 25 mm and 40 mm, such as between 25 mm and 35 mm, between 30 mm and 35 mm, or about 32 mm as measured by ASTM D3787.

A textile with such a high bursting strength is particularly suitable for containing, storing, and transporting heavier materials and goods, while avoiding the bursting of the textile.

In an embodiment, the thickness of the textile is between 0.40 mm and 0.60 mm, preferably between 0.45 and 0.60 mm, between 0.40 and 0.55 mm, or between 0.45 and 0.55 mm, such as 0.50 mm, preferably as measured by EN 20534. A textile having such a thickness is sufficiently strong to carry heavy items, yet sufficiently flexible to be used in returnable packaging of transported piece goods.

In an embodiment, the dividers of the framework are composed from pieces of said textile as described in any of the above or below embodiments, wherein said pieces are sewn together by way of PP or PE seams. By providing PP or PE seams, also said seems can be recycled together with the whole of the textile, thereby increasing the sustainability of the framework.

The term ‘parallel seam strength’ refers to the strength of a seam in the direction parallel to the direction of the seam. This is typically measured by the ASTM D5035 standard, which describes a test method for determining the breaking strength and elongation of textile fabrics using a grab method. In the context of seam strength, the ASTM D5035 test is used to measure the breaking strength of a seam in the direction parallel to the direction of the seam.

The term ‘perpendicular seam strength’ refers to the strength of a seam in the direction perpendicular to the direction of the seam. This is also measured by the ASTM D5035 standard, which provides a standardized method for testing the strength of textile fabrics and seams. In the context of perpendicular seam strength, the ASTM D5035 test is used to measure the breaking strength of a seam in the direction perpendicular to the direction of the seam.

In a further embodiment, the parallel seam strength in both directions (MD and CD) is between 250 N and 450 N as measured by ASTM D 5035. Preferably the parallel seam strength is between 260 N and 440 N, between 280 N and 430 N, between 300 N and 420 N, between 320 N and 410, between 340 N and 400 N, or preferably between 345 N and 400 N, such as between 340 N and 360 N in the CD and between 390 N and 410 N in de MD. In a particular example, the parallel seam strength in the CD is 349 N and in the MD about 399 N.

In another or further embodiment, the perpendicular seam strength in both directions is between 50 and 100 N as measured by ASTM D 5035. Preferably the perpendicular seam strength is between 52 N and 90 N, between 54 N and 80 N, preferably between 56 N and 70 N, such as between 50 N and 60 N in the CD and between 60 N and 70 N in de MD. In a particular example, the perpendicular seam strength in the CD is about 58 N and in the MD about 68 N.

The invention is further described by the following non-limiting examples which further illustrate the invention, and are not intended to, nor should they be interpreted to, limit the scope of the invention.

The present invention will be now described in more details, referring to examples that are not limitative.

### EXAMPLES AND DESCRIPTION OF FIGURES

With as a goal illustrating better the properties of the invention the following presents, as an example and limiting in no way other potential applications, a description of a number of preferred embodiments of the framework of the invention and parts thereof are provided. Parameters as described in the examples were measured by the standard measuring methods as described above, unless when indicated differently.

### Example 1: Description of a Framework with Dividers According to an Embodiment of The Invention

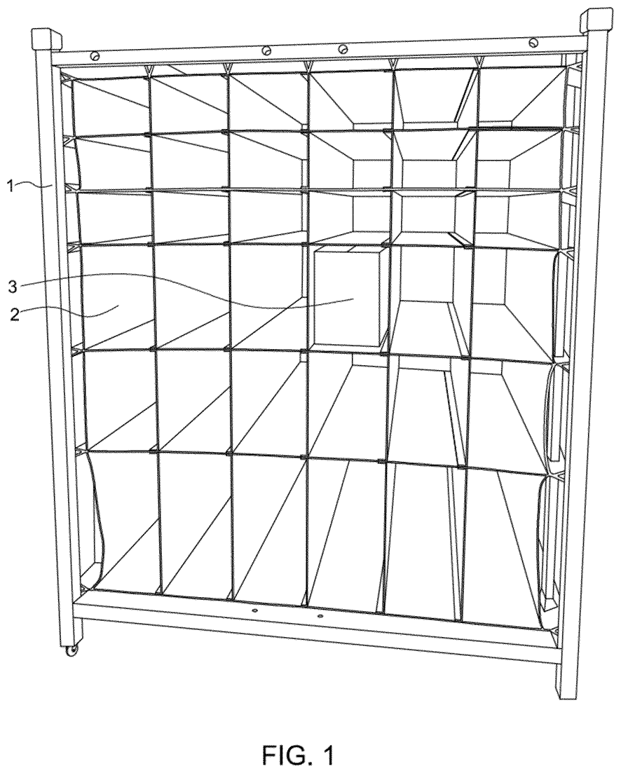

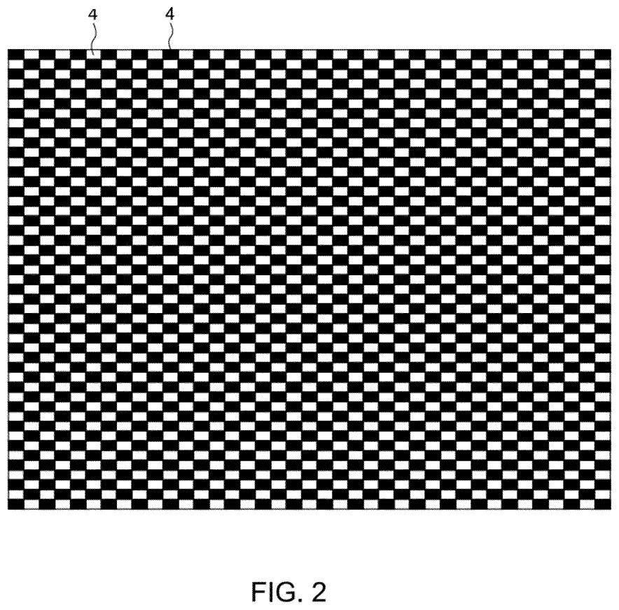

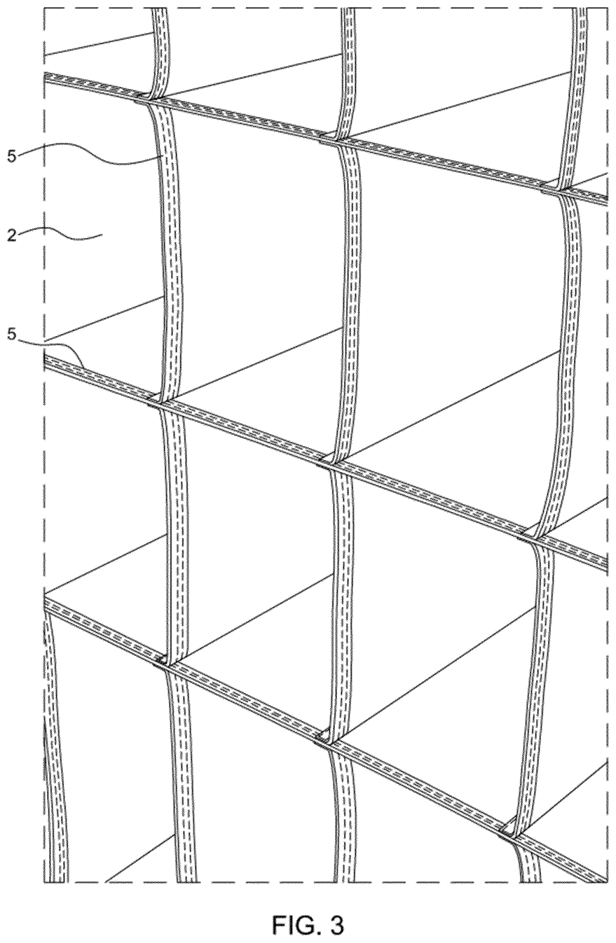

FIG. 1 schematically presents a framework (1) comprising dividers (2) for the storage and transport of piece goods (3), wherein the dividers are composed of a specific textile. FIG. 2 presents in more detail the textile of which the dividers are composed, and shown the multifilament yarns (4) of the scrim with a coating layer disposed on its surfaces. FIG. 3 presents a further view on the dividers (2) composed from pieces of said textile sewn together by way of seams (5). References to numbers refer to the corresponding numbers on FIGS. 1, 2 and 3.

A framework (1) provided with dividers (2) for the temporary storage and transport of piece goods (3) was provided in a transport container (not shown). The dividers (2) were composed of a textile comprising a woven PE (HDPE) scrim with a weight of 180 g/m² and PE (LDPE) coating layers with a combined weight of 165 g/m² disposed on both the first and second surface of the woven scrim. The scrim had 17 multifilament yarns (4) per inch in both the machine direction (MD) and cross direction (CD) of the scrim, and the textile had a total weight of 345 g/m². The thickness of the scrim was measured to be between 0.35 mm and 0.45 mm, and the total thickness of the textile was measured to be between 0.45 mm and 0.55 mm. Such low-weight textile is particularly interesting to be used in storing and transporting goods, as it reduces the total costs.

The breaking strength of the textile in both the MD and CD was measured to be more than 1900 N, with an elongation at break in both directions of between 19 and 26%. In particular, in the MD the breaking strength was measured to be 1980 N with an elongation of 25.3%, and in the CD this was 2140 N with an elongation of 19.7%. The tearing strength in the MD was 130 N and in the CD 148 N, while the bursting strength of the textile was measured to be 3526.4 N with a displacement of 32.6 mm.

The dividers were composed of pieces of the textile sewn together by way of PE seams (5), with a parallel seam strength in the MD 399 N and in the CD of 349 N, and a perpendicular seam strength in the MD of 67.8 N and in the CD of 57.9 N.

The framework was used in a transport container to transport various piece goods, including fragile items such as glassware and electronics, without any damage or breakage occurring during transport.

### Example 2: Comparison of Strength Characteristics Between the Used Textile of the Dividers of the Invention, and PVC-Based Textile

Characteristics of the textile of the dividers of the invention as described in example 1, having a total weight of 345 g/m², are compared to said characteristics of the known PES-PVC material used for a similar purpose, having a total weight of 550 g/m².

| | Textile as in example 1 | | | |
|---|---|---|---|---|
| | (PE scrim with PE coating) | | PES-PVC (Dejia) | |
| Average | Machine | Cross | Machine | Cross |
| result | direction | direction | direction | direction |
| Tearing | 130N | 148N | 152N | 81.1N |
| strength | | | | |
| Breaking | 1980N | 2140N | 2520N | 2220N |
| strength | elongation: | elongation: | elongation: | elongation: |
| | 19.7% | 25.3% | 24% | 25% |
| Perpendicular | 67.8N | 57.9N | 93N | 49N |
| seam strength | | | | |
| Parallel seam | 399N | 349N | 293N | 246N |
| strength | | | | |

| | Textile as in example 1 | | | |
|---|---|---|---|---|
| | (PE scrim with PE coating) | | PES-PVC (Dejia) | |
| Average | Maximum | Displacement | Maximum | Displacement |
| result | force (N) | (mm) | force (N) | (mm) |
| Bursting | 3526.4 | 32.6 | 3567.3 | 35.6 |
| strength | | | | |

From said results, it is clear that the textile as in the framework of example 1 has similar strength characteristics as PES-PVC, while being clearly lower in weight. Moreover, the PE-based dividers are recyclable, which PES-PVC material cannot be recycled. The dividers of the framework according to example 1 thus provide sufficient strength and flexibility to be used for storing and transporting piece goods, thereby avoiding tearing and breaking during transport, similarly as a corresponding PES-PVC material would provide.

### Example 3: Permanent Elongation Test Upon Applying a Load to the Textile

An in-house developed test was used to assess the permanent elongation of the dividers' textile upon applying a load. This test measures a material's ability to resist deformation or stretching over time when provided in a framework. Such tests are particularly relevant in textile production for applications like transportation of goods, where the material must withstand repeated stresses and strains without losing its structural integrity. Textiles are often used as cargo securing devices, such as cargo nets and tie-down straps, or as dividers for piece goods as in the present context. Such textiles are subject to repeated loading and unloading of cargo, which can cause the material to deform or stretch over time, which can compromise the safety and security of the cargo. If the material deforms too much, it may not be able to prevent different pieces of cargo coming in contact with each other, which could result in damaged goods.

The permanent elongation test helps to ensure that textile materials used in transportation of goods are able to withstand these stresses and maintain their structural integrity over time. The test involves subjecting the material to a specific load over a period of time and measuring the resulting deformation or elongation. The results of this test can then be used to evaluate the suitability of the material for use in cargo securing applications, and to make informed decisions about the selection of materials for these applications.

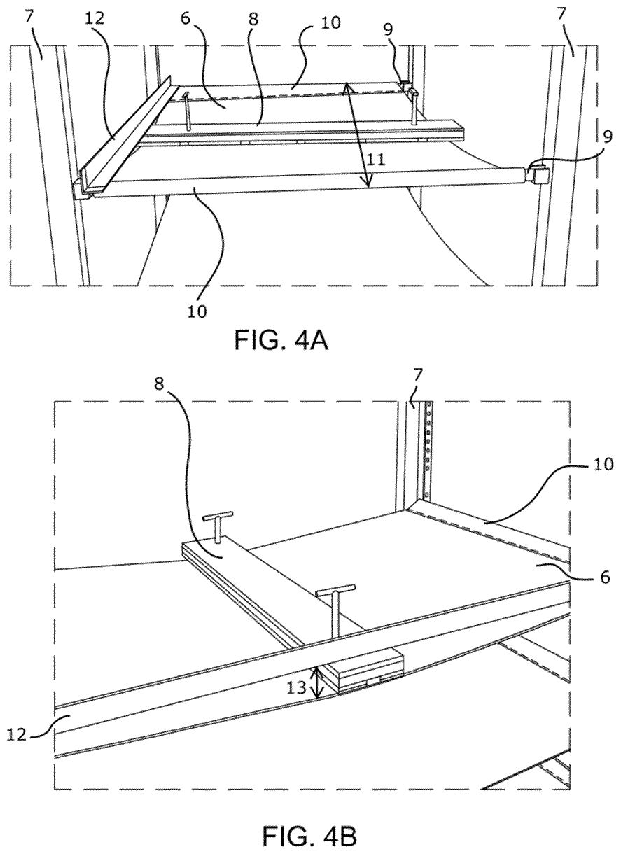

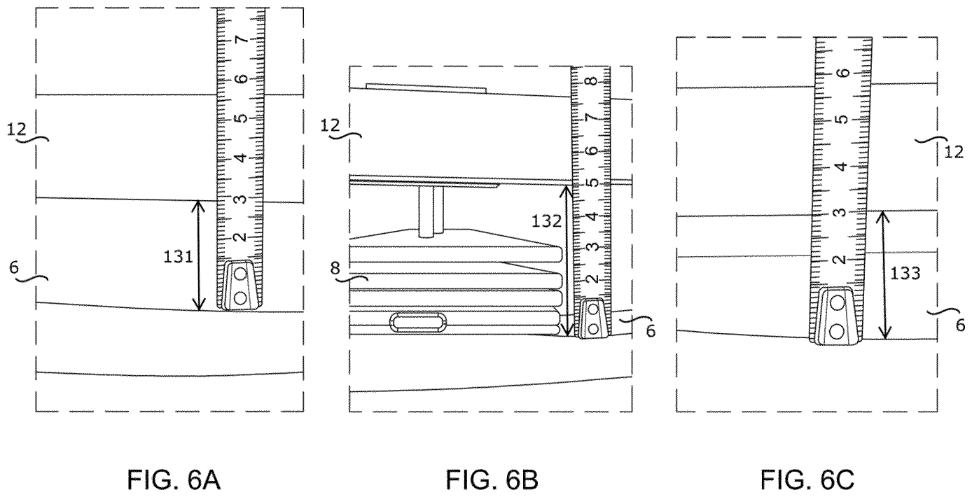

FIGS. 4, 5 and 6 show schematic representation of the testing set-up and the measured parameters, as described below. References to numbers refer to: the tested textile (6), the testing frame (7), the load (8), the tubes (9), the loops (10), the CC-distance (11), the slat (12), and the deflection (13, 131, 132, 133).

To perform the in-house developed test, the textile (6) is fastened over a frame (7), and a load (8) of 18 kg (a very heavy and worst-case testing weight) is placed in the middle of the textile. For this, the textile sheets can either have been cut in the machine direction or in the cross direction of the textile.

The test frame (7) provides two opposing tubes (9) at a same height, suitable to fix the textile to be tested to the frame using loops (10) provided at the side of the textile (6) that slide or can be stitched over the tubes (9). The distance between the centers of the tubes is referred to as the ‘CC’-distance or ‘center-center’-distance (11), for instance said CC-distance can be 1000 mm.

To fit the frame, the textile sheets are cut to a length of: [(the CC-distance)−(2×30 mm based on the tube diameter)]*a stretching factor of 0.992+(2×113 mm for the loops to fix the sides of the textile over the tubes). With a CC-distance of 1000 mm, this is: (1000 mm-60 mm)*0.992+226 mm=1.158.48 mm of sheet length. This step is crucial to ensure the material is always equally stretched at the start of the test before a load is applied, and thus to have a reproducible test.

The cut sheet is attached to the frame by stitching the loops to the opposing tubes at the same height. A straight reference slat (12) is placed over the opposing tubes (9) to clearly show the deflection/elongation of the material before the load is applied.

After the textile (6) and the slat (12) are positioned on the test frame (7; 9), a rectangular load (8) of 18 kg is placed in the center of the textile in the transverse direction, parallel to the tubes, for either 1 or 24 hours. The deflection (13; 131; 132; 133) of the material is checked after the load is removed for both time periods. Then, the textile sheet is removed from the frame, and the CC-distance (11) is recorded.

This test determines if the textile can withstand the stresses of transportation without significant deformation/elongation after the load is removed, which could compromise the safety and security of the cargo.

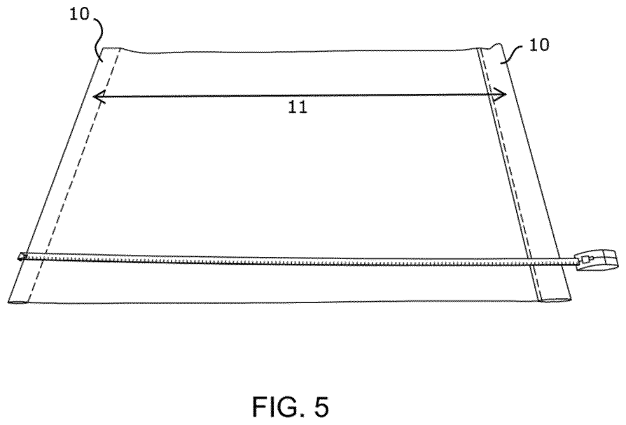

The CC-distance elongation was tested regarding the textile of Examples 1 and 2. The CC-distance was measured to be 1127 mm before applying the load, and remained 1127 mm after removing the load after 24 hours (FIG. 5; (11)). Therefore, the textile very resistant to permanent elongation.

A test regarding the deflection of the material when loaded and unloaded was also performed on the textile as used for the dividers in the framework of the invention (and from Examples 1 and 2). At a CC-distance of 1127 mm, the deflection without load was 29 mm (131). When an 18 kg load was applied, the deflection was 51 mm (132). The load remained on the textile for 24 hours, and after removing the load, the deflection was 30 mm (133). This again shows that the textile of the present concept is very resistant to permanent elongation.

A test regarding the deflection of the material upon applying the load of 18 kg and after 24 hours, was performed both on the known PVC-coated PES scrim and on the textile as used in the framework of the invention (and from Examples 1 and 2). As shown in the tables below, in particularly for the CD, the deflection upon loading (132) is 60 mm for the textile of the concept, while this is 65 mm for PVC-coated PES scrim. Even after 24 hours of applying the load, the deflection (132) is lower for the textile of the concept, compared to the PVC-coated PES scrim. Although the MD-cut PVC-coated PES scrim sheet seems to perform better, it must be emphasized that the pieces of textile used to compose the dividers are generally cut and sewn together in a mixed manner. The dividers thus generally comprise sheets cut in both the MD and CD. Therefore, the highest deflection values should be taken into account, which are 65 mm and 70 mm for PVC-coated PES scrim, while only being 60 mm and 65 mm for the textile of Examples 1 and 2.

The textile of the present concept thus outperforms the known PVC-coated PES scrim in all tests.

PVC-coated PES scrim

| | Cut in the CD | Cut in the MD |
|---|---|---|
| Deflection of material upon applying a | 65 mm | 38 mm |
| load of 18 kg | | |
| Deflection of material after applying the | 70 mm | 41 mm |
| load of 18 kg for 24 hours | | |

Textile of Examples 1-2

| | Cut in the CD | Cut in the MD |
|---|---|---|
| Deflection of material upon applying a | 60 mm | 55 mm |
| load of 18 kg | | |
| Deflection of material after applying the | 65 mm | 60 mm |
| load of 18 kg for 24 hours | | |

### Example 4: Permanent Elongation Test Upon Applying a Load to the Textile

An additional test was performed with a similar set-up as for Example 3, wherein other samples of the materials of Example 3 were used and compared. Results are shown in the tables below.

PVC-coated PES scrim

| | Cut in the CD | | Cut in the MD | |
|---|---|---|---|---|
| CC-distance before installing on test frame | 1130 | mm | 1127 | mm |
| Deflection of material upon applying a load of | 65 | mm | 38 | mm |
| 18 kg | | | | |
| Deflection of material after applying the load of | 70 | mm | 41 | mm |
| 18 kg for 24 hours | | | | |
| CC-distance after applying the load of 18 kg for | 1136 | mm | 1127 | mm |
| 24 hours | | | | |
| CC-distance 24 hours after load was removed | 1132 | mm | 1127 | mm |

The PVC-coated PES scrim showed the same deflection upon applying a load of 18 kg as seen for Example 3. In addition, it was shown that materials cut in the CD direction were flexible and showed elasticity-immediately after removing the load the CC-distance was 6 mm longer than at the start-however this elasticity is not seen in the MD as the CC-distance remains the same. 24 hours after moving of the load the CC-distance of the MD-cut sample is 2 mm longer than at the start.

Textile of Examples 1-2

| | Cut in the CD | | Cut in the MD | |
|---|---|---|---|---|
| CC-distance before installing on test frame | 1130 | mm | 1130 | mm |
| Bending of material without applying a load of | 15 | mm | 15 | mm |
| 18 kg | | | | |
| Deflection of material upon applying a load of | 65 | mm | 59 | mm |
| 18 kg (including original bending) | | | | |
| Deflection of material after applying the load | 75 | mm | 68 | mm |
| of 18 kg for 24 hours (including original | | | | |
| bending) | | | | |
| CC-distance after applying the load of 18 kg | 1135 | mm | 1133 | mm |
| for 24 hours | | | | |
| Deflection of material 1 hour after load was | 22 | mm | 17 | mm |
| removed (including original bending) | | | | |
| Deflection of material 24 hours after load was | 20 | mm | 17 | mm |
| removed (including original bending) | | | | |
| CC-distance 24 hours after load was removed | 1131 | mm | 1132 | mm |

The textile of Examples 1 and 2 was fasted on the test frame and showed an initial bending of the material (both for the MD- and CD-cut materials) without a load applied on it (131) of 15 mm. In the present example no data is available about the original bending without load of the PVC-coated PES scrim, and therefore it is difficult to compare the deflections under influence of the load.

The CC-distance for both the CD-cut material and the MD-cut material is higher (respectively 5 and 3 mm longer) immediately after the load is removed compared to the starting CC-distance, and is only either 1 or 2 mm longer 24 hours after the load was removed. The textile of Examples 1-2 is thus more elastic in both directions compared to the PVC-coated PES scrim (which had no increased CC-distance immediately after the load was removed for the CD-cut sample), and is very resistant to permanent elongation.

As indicated above, the framework with dividers composed of the textile as described in present invention has thus a particularly low weight, lower than a corresponding framework with dividers composed of a PVC-coated PES scrim would have, while providing sufficient strength and flexibility to be used for storing and transporting piece goods, thereby avoiding tearing and breaking during transport. In addition, the used textile is very resistant to permanent elongation, because of which it can be re-used multiple times even after heavy loads being applied. Finally, the dividers are recyclable, and thus a more sustainable option compared to PVC-coated PES dividers.

The present invention is in no way limited to the embodiments described in the examples and/or shown in the figures. On the contrary, frameworks according to the present invention may be realized in many different ways without departing from the scope of the invention.

1. A framework comprising:
dividers for the temporary storage and transport of piece goods, wherein the dividers are composed of a textile, said textile having a weight of maximally 400 g/m², the dividers further comprising:
a) a woven polypropylene (PP) or polyethylene (PE) scrim, said scrim having a first and a second surface, and
b) a PP or PE coating layer disposed on said first and/or second surface of the woven scrim;
characterized in that said scrim has a weight of maximally 200 g/m² and wherein one coating layer has a weight of maximally 100 g/m² as measured by EN 12127.

2. The framework according to claim 1, wherein the woven scrim is the PP scrim and the coating layer is the PP coating layer, or wherein the woven scrim is the PE scrim and the coating layer is the PE coating layer.

3. The framework according to claim 1, wherein said scrim comprises a machine direction (MD) and a cross direction (CD), wherein said scrim comprises a set of PP or PE multifilament yarns in the MD and a set of PP or PE multifilament yarns in the CD, wherein said scrim has 15 to 19 yarns per inch of scrim in both the MD and CD.

4. The framework according to claim 1, wherein the textile has a weight of maximally 350 g/m².

5. The framework according to claim 1, wherein the scrim has a weight of between 170 g/m² and 190 g/m².

6. The framework according to claim 1, wherein both surfaces of the woven scrim include the coating layer, and wherein the coating layers have a combined weight of maximally 200 g/m².

7. The framework according to claim 1, wherein said textile comprises a machine direction and a cross direction, wherein the breaking strength in both directions is at least 1500 N with an elongation at break in both directions of between 15 and 28% as measured by ASTM D 5035.

8. The framework according to claim 1, wherein said textile comprises a machine direction and a cross direction, wherein a tearing strength in the machine direction and the cross direction is at least 125 N as measured by ASTM D 5587.

9. The framework according to claim 1, wherein a bursting strength of said textile is at least 3000 N with a displacement of at least 25 mm as measured by ASTM D 3787.

10. The framework according to claim 1, wherein a thickness of the textile is between 0.40 and 0.55 mm.

11. The framework according to claim 1, wherein a thickness of the scrim is between 0.20 and 0.35 mm.

12. The framework according to claim 1, wherein said dividers are composed from pieces of said textile sewn together by way of PP or PE seams.

13. The framework according to claim 12, wherein said textile comprises a machine direction and a cross direction, wherein a parallel seam strength in the machine direction and the cross direction is between 250 and 450 N as measured by ASTM D 5035.

14. The framework according to claim 12, wherein said textile comprises a machine direction and a cross direction, wherein a perpendicular seam strength in the machine direction and the cross direction is between 50 and 100 N as measured by ASTM D 5035.
